(19) United States
(12) Patent Application Publication
(10) Pub. No.: US 2009/0212547 A1
(43) Pub. Date: Aug. 27, 2009

(54) Crash-Protected Steering Device Of A Vehicle

(75) Inventor: Stephan Heger, Handeloh (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, Stuttgart (DE)

(21) Appl. No.: 11/661,191

(22) PCT Filed: Aug. 19, 2005
(86) PCT No.: PCT/EP2005/008986

§ 371 Date: May 4, 2009

(30) Foreign Application Priority Data
Aug. 27, 2004 (DE) 10 2004 041 433.5

(51) Int. Cl. B62D 1/19

(52) U.S. Cl. 280/777

(57) ABSTRACT

Crash behavior is to be made variable in an application-dependent manner in a crash-protected steering device. For this purpose, the steering device of this type is provided with a piezoelectric actuator for a controllable reduction in a presettable crash or release force.

The invention relates to a crash-protected steering device of a vehicle, according to the preamble of patent claim 1.

Crash-protected steering devices are known in a wide variety of embodiments. Crash slides which are likewise known in different embodiments are frequently used as crash elements.

DE 100 55 114 C2 has disclosed an adjustable, crash-protected steering device, in which the release force, at which mutual, energy-consuming displacement of crash elements which are provided for this purpose is to take place in the case of a crash, can be set and controlled by a piezoelectric actuator. The release force which has to be overcome, in order to trigger mutual displacement of the crash elements which are intended for this purpose in the case of a crash, is applied actively here by the piezoelectric actuator, it being possible for this force to be controlled upward and downward in a variable manner for different desired crash conditions. The release force has a dual function in the embodiment according to DE 100 55 114 C2. Firstly, it serves to make the longitudinal adjustability of the steering device possible, and secondly it serves to make it possible for the action of the crash device to be controlled in a variable manner according to the application in the case of a vehicle crash.

The invention is concerned with the problem of providing a control device in addition to a crash device which is functional per se and optionally can also be preset in a fixed manner with regard to the release force, in a crash-protected steering device of the generic type, with which control device the preset release force can be reduced in a variable manner according to the application, in order to influence the crash behavior. A variable manner according to the application means that, for example, in a crash, parameters which are specific to the user, the driving style and the crash can be taken into consideration in order to influence the crash behavior. As a result, the safety of the driver in the case of an accident is to be increased still further beyond the degree which has already been achieved in the prior art to date.

This object is achieved by a crash-protected steering device having the features of claim 1.

One particularly expedient refinement of the device of this type is the subject matter of the subclaim.

The invention is based on the general concept of it being possible to use the crash slide design which is known per se as a crash element within the steering device, and to change only the release force which is critical in the case of a crash in a variable manner depending on the application for activation of the crash element and functioning of the crash element with the aid of a piezoelectric actuator.

One particularly advantageous exemplary embodiment which is directed at a crash slide device and will be explained in further detail in the following text is shown in the drawings, in which:

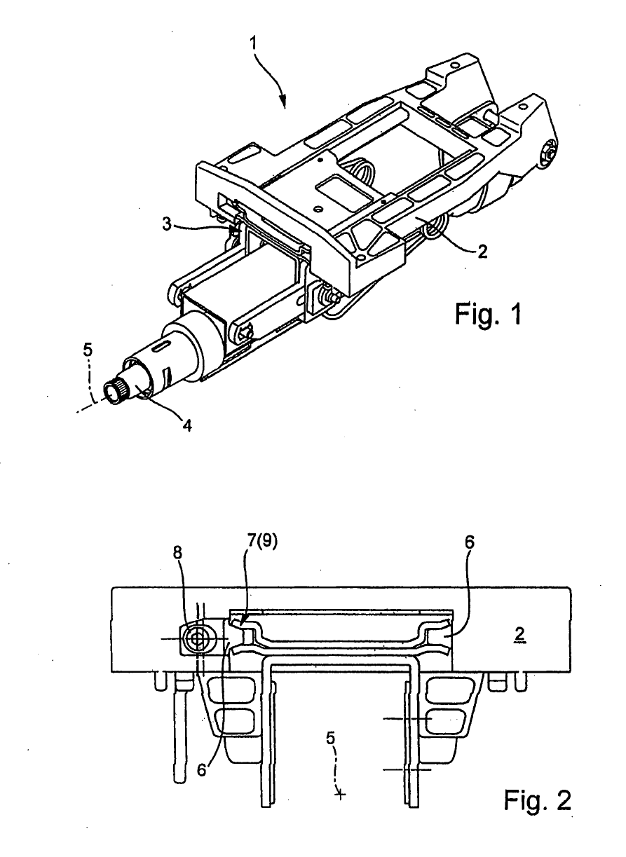

FIG. 1 shows a steering device having a crash slide as crash element,

FIG. 2 shows a view of only the crash slide apparatus in FIG. 1, and

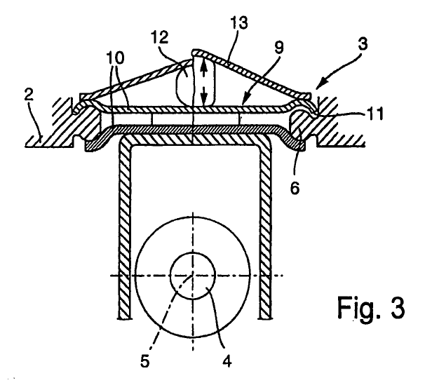

FIG. 3 shows a detail from FIG. 1 with a piezoelectric actuator which is used according to the invention.

A steering column arrangement 1 for a motor vehicle has a bracket 2 which can be fastened to a vehicle superstructure (not shown), and a steering shaft 4 which is arranged on the bracket 2 via a crash device 3. The crash device 3 performs the function of a crash slide. Here, the steering shaft 4 serves to transmit a steering movement from a steering handle (not shown) to a steering gear (likewise not shown).

In order to reduce an impact of the driver onto the steering handle (not shown) and therefore onto the rigid steering shaft 4, the latter is mounted such that it can be displaced with regard to the bracket 2 parallel to the steering shaft axis 5 via the crash device 3 when a predefined crash force is exceeded. Here, the predefined crash or release force can be set individually to different requirements via the crash device 3.

The crash device 3 has at least one first guide element 6 and at least one second guide element 7 which interacts with the former, of which one is arranged in and axially fixed manner on the steering shaft 4 and the other is arranged fixedly on the bracket 2 (FIG. 2). In the normal state, that is to say in the usual operating state of the vehicle, the steering shaft 4 cannot be displaced with regard to the bracket 2, even when the forces which occur in a usual manner in the operating state are applied. Moreover, a displacement of the steering shaft 4 with regard to the bracket 2 is likewise not possible up to predefined misuse forces. Only in the case of a crash, that is to say when the predefined release force is exceeded, does the crash device 3 permit displacement of the steering column 4 along the steering column axis 5 with regard to the bracket 2.

As different requirements, such as a different weight of the driver, a different driving speed at the beginning of a crash scenario and the like, can require a different magnitude of the predefined crash force, it is advantageous for it to be possible to preset the crash force, that is to say the release force for the crash device 3, by, for example, an adjusting device 8.

In the normal state, the first guide element 6 which is arranged on the adjusting device can be clamped with regard to the second guide element 7 by an adjusting device 8 of this type and generates an active frictional connection as a result in the guide direction, that is to say substantially in the direction of the steering shaft longitudinal axis 5. The magnitude of the frictional connection and of the static friction force which is to be overcome, and therefore of the crash or release force, depends on the clamping force which can be set on the adjusting device 8.

The adjusting device 8 is only an optional device which can also optionally be omitted. In one exemplary embodiment (not shown), in which an adjusting device 8 of this type as described in the preceding text is not provided, the corresponding clamping/crash force is defined solely by the perpendicular force which is established during manufacturing and with which the guide element 7 is pressed against the guide element 6.

Independently of the clamping or release force which is set, for example, by the adjusting device 8, the activation of the crash element in the event of a crash can already be achieved according to the invention below the preset release force. For example, a device which is shown in FIG. 3 can serve for this purpose. In this device, the second guide elements 7 comprise a clamping device 9 having in each case one pair of clamping webs 10 at two opposite ends in order to form in each case one clamping jaw 11. On one of the two clamping webs 10, a piezoelectric actuator 12 is provided approximately centrally between the two clamping jaws 11. This piezoelectric actuator 12 is arranged in such a way that it is clamped between the relevant clamping web 10, to which it is assigned, and a pulling lug 13. Here, the pulling lug 13 is connected fixedly to the ends of the clamping web 10, to which the piezoelectric actuator 12 is assigned.

FIG. 3 shows the crash device 3 in the non-actuated state of the piezoelectric actuator 12 on the left-hand side of the axis of symmetry which extends in the vertical direction, and in the actuated state of the piezoelectric actuator 12 on the right-hand side of the axis of symmetry.

If the piezoelectric actuator 12 is extended, which preferably takes place by application of an electric voltage to the latter, which takes place when it is activated, the clamping force in the clamping jaws 11 is reduced, as indicated on the right-hand side of FIG. 3 by a corresponding deformation of the upper clamping web 10. Here, its deformation is shown in an exaggerated manner for the sake of clarity. In the case of only a desired reduction in the clamping force, it goes without saying that the clamping web 10 still has to bear against the first guide elements 6 of the bracket 2 with a reduced release force.

The crash behavior of the crash device can be varied by way of the actuator 12 in a very wide variety of ways and specifically with regard to the user, the driving style and the accident, all the possible variations which are specified in DE 100 55 114 C2 being possible here in principally the same way.

All the features which are shown in the description and in the following claims can be essential to the invention, both individually and in any desired combination.

1-2. (canceled)

3. A crash-protected steering device of a vehicle, comprising:
a first guide element connected to a vehicle superstructure, and
a second guide element connected to the first guide element, the first and second guide elements being connected to one another for energy-consuming displacement with respect to one another, during a vehicle crash, with a presettable release force, and
a piezoelectric actuator provided for a controllable reduction in the preset release force.

4. The steering device as claimed in claim 3, further comprising a bracket which can be fastened to a vehicle superstructure.

5. The steering device as claimed in claim 4, further comprising a steering shaft which is arranged on the bracket via a crash device and mounted on the bracket such that it can be displaced parallel to a steering shaft longitudinal axis when a predefined releasing force is exceeded.

6. The steering device as claimed in claim 5, wherein the crash device has at least the first guide element and at least the second guide element, and wherein one of the guide elements is arranged in an axially fixed manner on the steering shaft and the other of the guide elements is arranged fixedly on the bracket.

7. The steering device as claimed in claim 6, wherein the first and second guide elements interact in such a way that they guide the steering shaft substantially axially on the bracket.

8. The steering device as claimed in claim 7, wherein the second guide element is connected to the steering shaft and is configured as a clamping web device with a pair of clamping webs which lie opposite one another.

9. The steering device as claimed in claim 8, wherein ends of the clamping webs which lie opposite one another form clamping jaws for clamping the first guide elements with a presettable release force.

10. The steering device as claimed in claim 9, wherein the piezoelectric actuator is connected to at least one of the clamping webs in a force-transmitting manner in order to permit a reduction in the release force in the respective clamping jaw to be generated upon activation.
